(19) United States
(12) Patent Application Publication
(10) Pub. No.: US 2026/0342063 A1
(43) Pub. Date: Oct. 29, 2026

(54) POWER BASE WITH MODULAR ACCESSORIES

(71) Applicant: TEXTRON AVIATION INC., Wichita, KS (US)

(72) Inventor: Patrick Allen Stanton, Rose Hill, KS (US)

(21) Appl. No.: 19/191,464

(22) Filed: Apr. 28, 2025

(51) Int. Cl. H02G 3/16

(52) U.S. Cl. CPC H02G 3/16

(57) ABSTRACT

A modular power base system having a base plate and various faceplates that each fit onto that base plate and are interchangeable with each other. The base plate has a first non-conductive structure for mounting through an opening in a surface or wall and includes base plate guides. Electrically conductive elements extend through the first non-conductive structure and may be wired to a power source. One or more faceplates may be selectively attachable to the base plate to reconfigure the outlets and accessories made available to users therefrom. The faceplates may each include a second non-conductive structure having faceplate guides for selectively engaging with the base plate guides and locking into place onto the base plate. Some of the faceplates may have one or more outlets or electronic accessories built into or extending through the second non-conductive structure and electrically coupled with the electrically conductive elements of the base plate.

### BACKGROUND OF THE INVENTION

When different outlets are needed in place of existing outlets in or on a wall or panel of a home, vehicle, or aircraft, quite a few different changes may be needed. For example, the hole cut into the wall or panel may be of a different size depending upon what types of outlets, switches, and/or various electronic accessories were included therein. Likewise, different electrical and wiring needs may require additional modifications to the electrical wiring and the wall or panel.

Some swapable, standard-sized outlet wall plates, such as Decora outlets manufactured by Leviton based in Melville, New York, can use the same mounting provisions, even if different styles or shapes of outlets are provided in the wall plate. Such outlet wall plates provide a wide variety of options for outlets, from 110v outlets to USB outlets to lighting, switching, and the like. However, swapping out those different varieties or styles of outlet wall plates requires shutting off electricity and the use of various tools. Specifically, the power must first be switched off, and then a voltage meter should be used to ensure that the power to the wires is off. Next, the old outlet's wall plate must be unscrewed from the wall, and the wire nuts or electrical tape removed to separate wall wires from connectors on the old outlet. Then the new outlet may use wire nuts for secure connections to the wall wires and electrical tape for insulation and safety. Finally, the wall plate must be screwed back into the wall and the power must be turned back on to test that the outlet is working. This process is time-consuming and can be dangerous without the proper equipment, making it more cumbersome for the average user when different configurations of outlets are desired for changing needs.

Thus, there is a need for systems and methods for swapping out different styles of electrical outlets that do not suffer from these and other deficiencies of the prior art.

### SUMMARY OF THE INVENTION

Embodiments of the current invention address one or more of the above-mentioned problems and provide a distinct advance in the art of electrical outlets. In one embodiment, the power base system includes a base plate and one or more faceplates. The base plate includes a first non-conductive structure mountable through an opening in a surface and having one or more base plate guides. The base plate also includes one or more electrically conductive elements extending through the first non-conductive structure and electrically attachable to a power source. The one or more faceplates include a second non-conductive structure having one or more faceplate guides for selectively engaging with the one or more base plate guides and locking into place onto the base plate. The one or more faceplates also include one or more outlets or electronic accessories built into or extending through the second non-conductive structure and electrically couplable with the one or more electrically conductive elements.

In another embodiment, a power base system includes a base plate and at least one faceplate. The base plate includes a first non-conductive structure for affixing to a surface and extending at least partially through an opening in the surface. The first non-conductive structure further includes one or more base plate guides and one or more electrically conductive elements extending through the first non-conductive structure for wired attachment to a power source. The at least one faceplate includes a second non-conductive structure having one or more faceplate guides for selectively engaging with the one or more base plate guides and at least one locking feature for locking the at least one faceplate at a position fully seated onto the base plate.

In yet another embodiment, a method of reconfiguring a power base system with different physical or electronic accessories or outlets includes a step of sliding a first faceplate off of base plate guides of a base plate that is mounted to a surface. The base plate is electrically coupled to a power source. The method also includes sliding a second faceplate onto the base plate guides until snapped together or otherwise secured or fixed onto the base plate, as well as electrically coupling electrical contacts of the base plate and the second faceplate with each other. Furthermore, the method includes a step of inserting an electrical plug into an outlet of the second faceplate.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF DRAWINGS

Embodiments of the current invention are described in detail below with reference to the attached drawing figures, wherein:

FIG. 1 is a front perspective view of the power base system in accordance with embodiments herein;

FIG. 2 is a front exploded perspective view of the power base system of FIG. 1;

FIG. 3 is a rear exploded perspective view of the power base system of FIG. 2;

FIG. 4 is a front perspective view of an alternative embodiment of a power base system in accordance with embodiments herein;

FIG. 5 is a front exploded perspective view of the power base system of FIG. 4;

FIG. 6 is a rear exploded perspective view of the power base of FIG. 5; and

FIG. 7 is a method flow chart of reconfiguring a power base system in accordance with embodiments herein.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE INVENTION

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

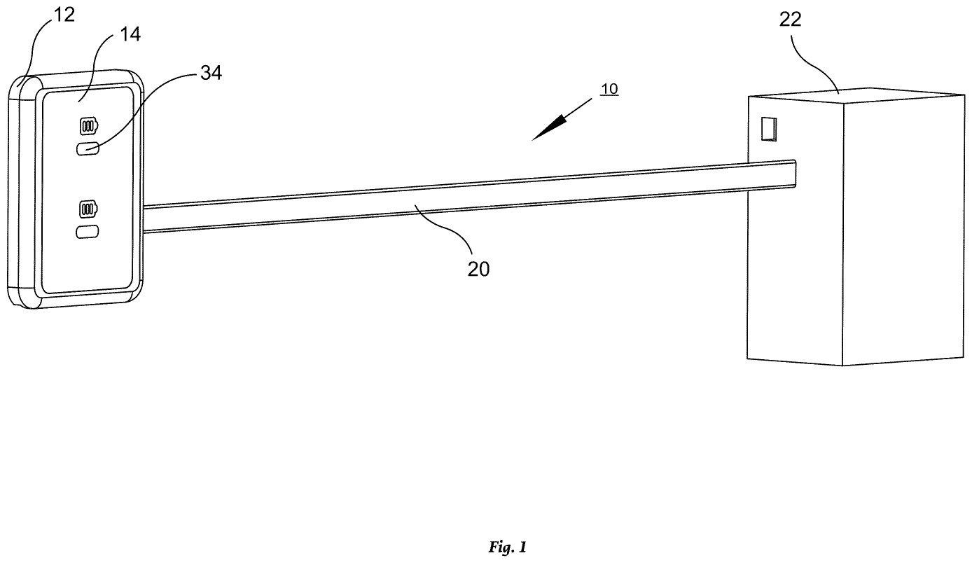

As depicted in FIGS. 1-3, a power base system 10 of the present invention is configured for convenient swapping out of different styles or configurations of electrical outlets, electrical accessories, or the like. Specifically, the power base system 10 comprises a base plate 12 and one or more faceplates (e.g., the faceplate 14) configured to selectively mechanically slide onto and/or lock or engage with the base plate 12, and to also automatically electrically couple with conductive components 16 of the base plate 12. Once the faceplate 14 is fully seated onto the base plate 12, spring-biased components and/or locking mechanisms 18,19 of one or both of the base plate 12 and the faceplate 14 seated thereon may engage with the other of the faceplate 14 or the base plate 12, such that the physical and electrical coupling therebetween is secure.

In some embodiments, as depicted in FIGS. 1-3, the power base system 10 described herein may further include and/or be electrically coupled to one or more wires or cords 20 and a primary power source module 22 (e.g., a universal 28V power module). In one or more embodiments, the primary power source module 22 may comprise a power controller and may be housed in a relatively thin, surface-mounted housing. For example, the primary power source module 22 may be a 28V module always powered on or configured to be powered on and off by a local or remote switch. However, other power sources with other voltages may be used without departing from the scope of the technology herein. The power controller may comprise one or more processing elements or circuitry as known in the art for controlling, monitoring, or even reconfiguring various aspects of the primary power source module 22 based on aircraft requirements and/or which one of the faceplates (e.g., 14) is coupled with the base plate 12 as described below. The primary power source module 22 may comprise any number of reconfigurable features or customizable features without departing from the scope of the technology herein.

The base plate 12 may comprise a simple power base configured to be permanently or mechanically installed onto a surface such as a vertical or horizontal surface. For example, the surface may include a wall, a horizontal ledge, a floor, a ceiling, or the like with a hole or opening cut or formed therethrough, such that the base plate 12 at least partially extends through the hole or opening and is mechanically attached to the surface. The base plate 12 may be made of a plastic element or first non-conductive structure 24 supporting therein and/or therethrough one or more of the electrically conductive elements 16. The first non-conductive structure 24 of the base plate 12 may comprise one or more holes 26 sized and configured to receive bolts or other attachment fasteners to mount the first non-conductive structure 24 of the base plate 12 to the surface as described above.

An electric wire or cable (e.g., the cord 20) behind the surface or wall may carry electricity from the primary power source module 22 to the electrically conductive elements 16 of the base plate 12. For example, the cord 20 or wires thereof may be wired or otherwise placed in fixed contact with the electrically conductive elements 16 on a back side of the base plate 12, and at least one surface of the electrically conductive elements 16 may be accessible from a front surface of the base plate 12, such as through holes or openings formed through the first non-conductive structure 24. In some embodiments, at least one of the electrically conductive elements 16 may be electrical contacts, conductive electrical pads, spring-biased conductive pads, and/or conductive spring pins providing electrical power to other electrically conductive elements of the faceplates 14, as later described herein. In one example embodiment, the base plate 12 has spring-biased pads that provide electrical power (e.g., 28VDC) to any faceplate outlets or electronic accessories coupled thereto. In one or more embodiments, in addition to the electrical wires or electrical cables, data connection wires or cables may additionally or alternatively be hardwired to the base plate, allowing for wired internet connections or the like, in addition to serving as a source of electrical power.

The first non-conductive structure 24 of the base plate 12 may comprise one, two, or more base plate guides 28 to align the faceplate 14 (or any selected ones of a plurality of faceplates) onto the base plate 12. For example, the baseplate guides 28 may include one or more tracks or rails engageable with tracks, rails, or other protrusions of the faceplates in order to align and/or lock the faceplate 14 into place on the base plate 12, with the electrically conductive elements 16 of the base plate 12 engaging with electrically-conductive elements of the faceplate 14 in the locked position or locked configuration. Furthermore, the base plate guides 28 or other elements of the base plate 12nmay be configured to lock with guides or other elements of the faceplate 14 as later described herein. For example, the first non-conductive structure 24 of the base plate 12 may also comprise one or more locking features (e.g., notches, flexible interlocking or engaging features, or the like) configured to flex or to cause components of the faceplates (e.g., the faceplate 14) to flex in order to engage with one or more features of the faceplate 14. The first non-conductive structure 24 of the base plate 12 may also then flex again or cause components of the faceplate 14 to flex in order to disengage with locking features of the faceplates described below.

The faceplate 14 may be configured to engage with the base plate 12 and may comprise another plastic element or second non-conductive structure 30 having one or more faceplate guides 32 configured for selectively engaging with the base plate guides 28 and locking into place onto the base plate 12 via the locking mechanism 19 of the faceplate 14. In one or more embodiments, the plastic elements or non-conductive structures 24, 30 of the base plate 12 and the faceplate 14, respectively, may be made of other non-conductive materials besides plastic without departing from the scope of the technology described herein. In one or more embodiments, the faceplate guides 32 may comprise one, two, or more guides (e.g., integrated alignment provisions) such as rails, tracks, protrusions, or the like configured for providing alignment with the base plate guides 28 of the base plate 12.

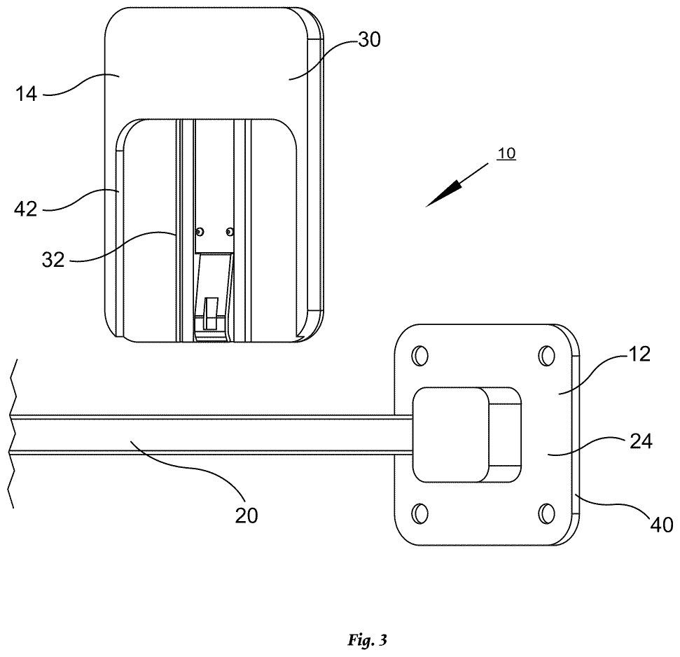

The locking mechanism 19 of the faceplate 14 and the base plate 12 may be configured to cooperatively engage with each other when the faceplate 14 is fully seated onto the base plate 12, thereby mechanically locking the faceplate 14 onto the base plate 12. Disengagement of the locking mechanisms 18,19 may occur when sufficient force is provided to the faceplate 14 to flex at least one of the locking mechanisms 18,19 of the faceplate 14 and/or the base plate 12, as later described herein. For example, the second non-conductive structure 30 may comprise one or more locking features or the locking mechanism 19 that is configured to flex and/or be spring-biased to engage with and then flex again to disengage with locking features or interlocking features (e.g., the locking mechanism 18) of the first non-conductive structure 24 of the base plate 12. However, other mechanical locking mechanisms may secure the faceplate 14 onto the base plate 12 without departing from the scope of the technology described herein. Furthermore, for additional alignment and placement purposes, as depicted in FIG. 3, an external edge 40 of the base plate 12 may be sized, shaped, or otherwise configured to abut a wall 42 of a cutout region of the faceplate 14 or to otherwise nest within the wall 142 of the cutout region of the faceplate 114 when the faceplate 14 is slid onto and fully seated onto the base plate 12.

The faceplate 14 may also include one or more outlets 34 or electronic accessories built into or extending through the second non-conductive structure 30 and configured to electrically couple with the electrically conductive elements 16 of the base plate 12. Furthermore, the electrically conductive elements 16 of the base plate 12 may engage with electrically conductive elements of the outlets 34 and/or electronic accessories of the faceplate 14 in the locked position or locked configuration (e.g., conductive pads engaging with spring-biased contacts or the like). For example, electrically conductive elements of the outlets 34 and/or the electronic accessories may extend rearward from the faceplate 14 toward the base plate 12 and make contact with the electrically conductive elements 16 of the base plate as described in various example embodiments herein. The faceplate 14 described and depicted herein is merely exemplary, and can be configured in or swapped for faceplates of any size, shape, or configuration, as long as the faceplates each include guides (or other alignment provisions), locking mechanisms, and electrically conductive elements (e.g., spring-biased electrical contacts, pads, or pins) configured to engage with similar or mating components of the base plate 12 as described herein.

The faceplate 14 or any faceplates described herein may also comprise outlets or other electronic accessories configured to handle any change in voltage, such as aircraft power of 28V to 5vdc for USB charging or the like, via circuitry built into the faceplate 14 or faceplates for such conversion. This makes it easy to swap different faceplates due to the fact the base plate 12 always supplies the same power and is controlled by hardware or circuitry built into one or more of the faceplates if or when needed to convert down to whatever the electricity requirement is for that faceplate's built in accessories, outlets, switches, or the like. This allows for swapping unique accessories that would require the same amount of power, low voltage light, or USB modules that take the same amount of 5-volt power.

The faceplate 14 or any of the other faceplates described herein may comprise any type of charging port or charging system wired or wireless. For example, the faceplates may comprise two or three-prong plug ports, USB ports (e.g., USB-A, USB-B, USB-C, Mini-USB, Micro-USB, USB 1.1, USB 2.0, USB 3.0 Type B, USB4, or the like), a Lightning port or 30-Pin dock connector (as both used by APPLE products), car charger ports, wireless charging systems, HDMI ports, and the like. In addition to electrical ports or sockets, other types of electrical devices or electronic accessories may be integrated into any of the faceplates described herein without departing from the scope of the technology herein, such as lights, speakers, wireless charging elements (e.g., wireless power transfer devices such as inductive chargers), or the like. Other types of wireless charging elements or wireless power transfer devices may be installed into one or more of the faceplates without departing from the scope of the technology herein, such as electromagnetic induction chargers, magnetic resonance chargers, electric field coupling chargers, radio reception chargers, or the like.

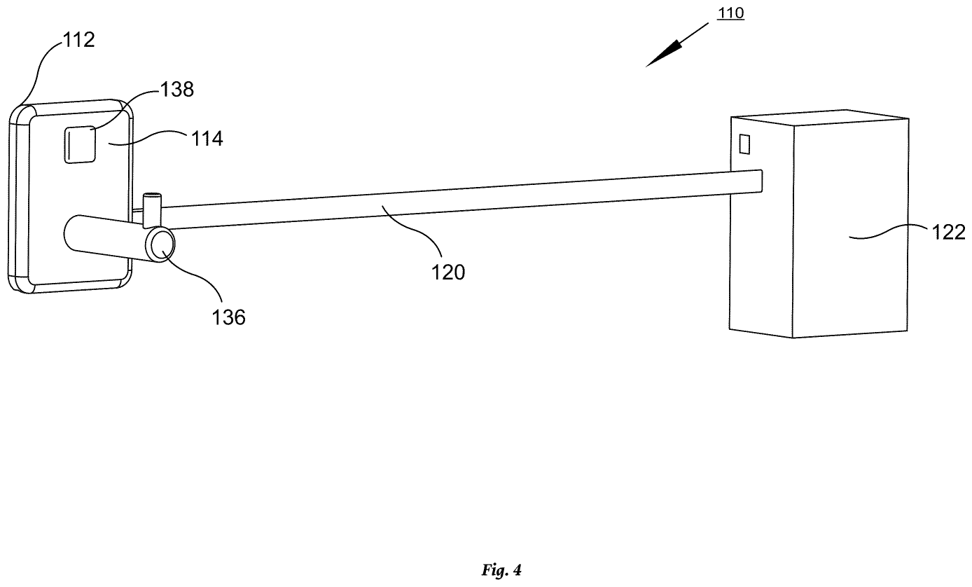

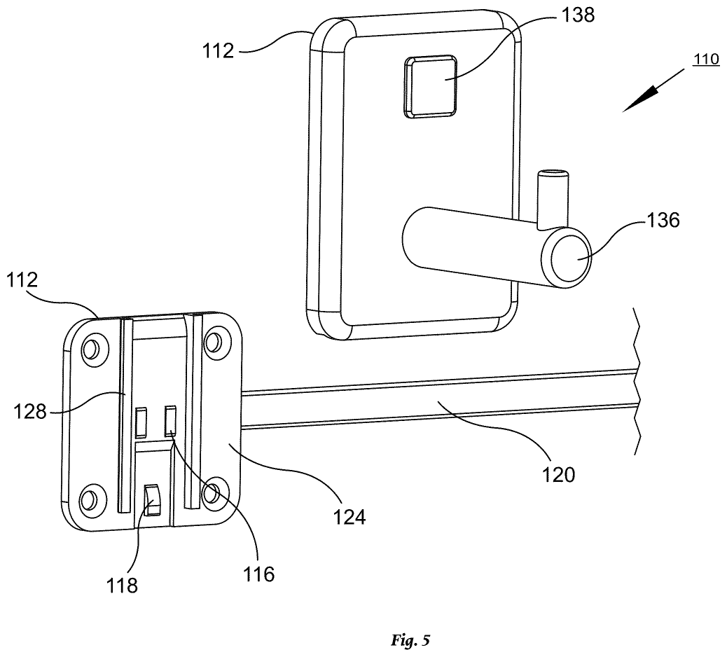

In some other alternative embodiments, one or more of the faceplates can merely be a cover (e.g., a solid plastic piece without any outlets accessible on a front side thereof). The cover may still include plastic locking elements so that if the base plate is not in use, the base plate's electrical pads or other such electrical contacts can be covered for safety purposes. In one or more embodiments, as depicted for an alternative power base system 110 in FIGS. 4-6, a faceplate 114 may include light sources such as nightlights or push-activated lights 138 (e.g., dome lights or courtesy lights). In addition to or as an alternative to powered outlets or electronic accessories (e.g., charging, lighting, or the like), one or more of the faceplates (e.g., the faceplate 114) may be configured with non-electrical accessories or items of convenience extending away from the base plate, such as coat hooks (coat hook 136 as depicted in FIG. 4), coat rods, towel holders, bottle openers, keychain holders, or any accessory typically mounted into and/or onto the surface such as a wall.

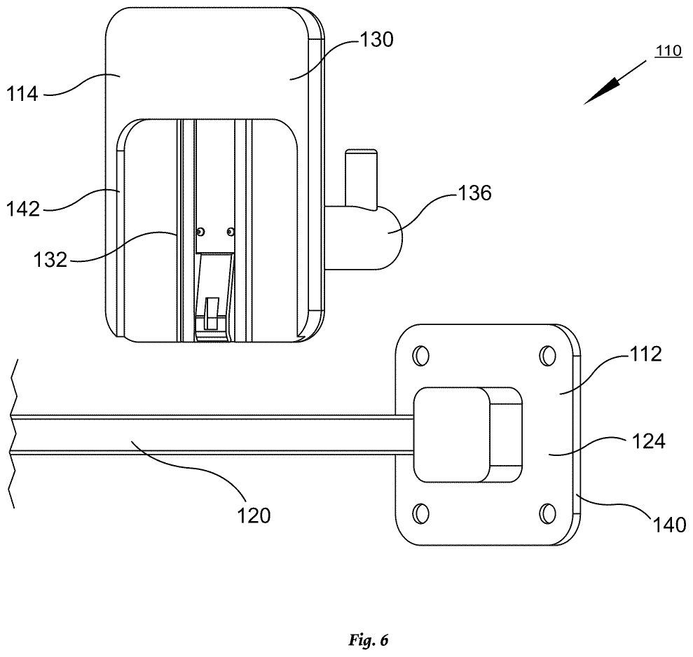

For example, while FIGS. 1-3 depict an embodiment with two outlets 34, other embodiments, as depicted in FIGS. 4-6, disclose the coat hook 136 and the light 138 on the faceplate 114 of the alternative power base system 110. The alternative embodiment of FIGS. 4-6 depicts the alternative power base system 110 having a base plate 112, the faceplate 114, conductive components 116, base plate locking mechanism 118, faceplate locking mechanism 119, cord 120, primary power source 122, first non-conductive structure 124, base plate guides 128, second non-conductive structure 130, and face plate guides 132 that are substantially the same or similar to the power base system 10, the base plate 12, the faceplate 14, the conductive components 16, the base plate locking mechanism 18, the faceplate locking mechanism 19, the cord 20, the primary power source 22, the first non-conductive structure 24, the base plate guides 28, the second conductive structure 30, and the faceplate guides 32, respectively, as described above and depicted in FIGS. 1-3. However, instead of the two outlets 34 as in FIGS. 1-3, the alternative power base system 110 comprises different accessories (e.g., the coat hook 136 and the light 138). Furthermore, as depicted in FIG. 6, an edge 140 of the base plate 112 may be sized, shaped, or otherwise configured to abut a wall 142 of a cutout region of the faceplate 114 or to otherwise nest within the wall 142 of the cutout region of the faceplate 114 when the faceplate 114 is slid onto and fully seated onto the base plate 112. Although the alternative power base system 110 comprises a slightly different mating configuration than the power base system 10, note that in some alternative embodiments the faceplate 14 or the faceplate 114 may be made with identical faceplate guides and locking mechanisms so as to be swappable with each other, such that these faceplates can be swapped out for each other without departing from the scope of the technology described herein.

Note that while two exemplary faceplate configurations are depicted in the drawing figures of FIGS. 1-3 and FIGS. 4-6, respectively, other faceplate configurations may be used without departing from the scope of the technology herein. For example, in some embodiments, the power base system herein may have at least two faceplates: a first faceplate that is a solid non-conductive cover for safety purposes when not being used and a second faceplate comprising one or more outlets or electronic accessories built into or through its non-conductive structure (e.g., either of the faceplates in FIGS. 1-6). Additionally or alternatively, there may be at least two faceplates in the power base system, and each of the two faceplates may comprise different styles, configurations, or quantities of electrical outlets, electronic accessories, or non-electronic accessories than each other. However, any number of faceplates may be included and/or swapped out as long as the faceplates are each designed to mate with the base plate, as with the exemplary embodiments described and/or depicted herein. Generally, the base plate, as depicted and described in the various embodiments herein, is configured to receive only one of the faceplates at once. However, in other alternative embodiments, more than one faceplate can be used with a single base plate, allowing for additional combinations of faceplate configurations.

In use, a first one of the faceplates may be slid off from the guides of the base plate, and a second one of the faceplates may be slide onto the guides of the base until snapped together or otherwise secured or fixed thereto via the locking features described above and/or the spring-biased pin of the second one of the faceplates. In some example embodiments, spring-biased pins line up with electrical pads of the base plate to provide power to outlets and/or electrical accessories of the second one of the faceplates. Enough force must be provided to the first one of the faceplates in order to flex one or more of the locking features described above in order to force these locking features to disengage with each other, so that sliding between the guides of the base plate and the faceplate is possible. The sliding off of the faceplates from the base plate may be performed in a substantially vertical upward direction when the base plate is installed onto a wall, for example. However, in some example embodiments, the faceplates may slide off of the base plate in horizontal directions, left or right, and/or in vertical downward direction, or any direction relative to the base plate. In some alternative embodiments, instead of sliding the faceplates off of the base plate in a direction of guides thereon, the guides may be replaced with other attachment means, clips, clamps, locks, or hand-released attachment components configured to selectively attach and selectively disengage the faceplates from the base plate without departing from the scope of the technology described herein.

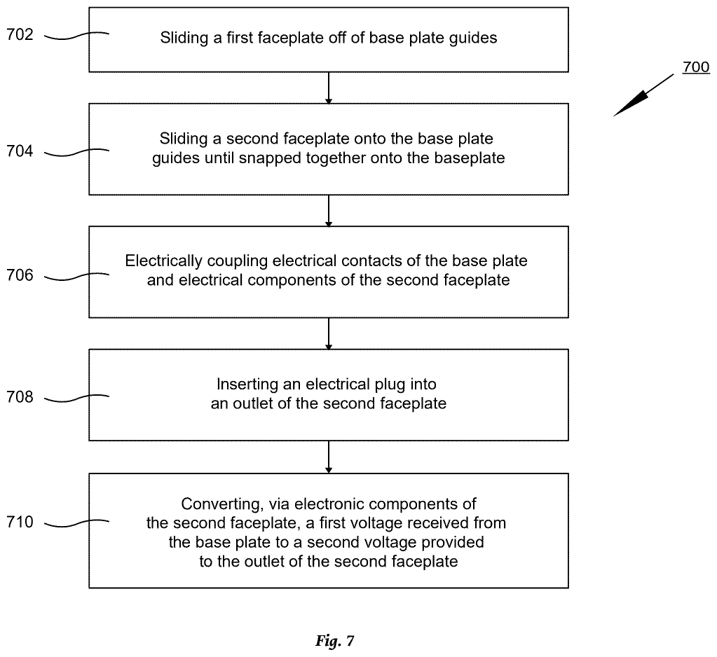

The flow chart of FIG. 7 depicts an exemplary method 700 of reconfiguring a power base system with different physical or electronic accessories or outlets/outlet ports, different quantities of outlets/outlet ports, or other varied configurations in more detail. In some embodiments, various steps may be omitted, or steps may occur out of the order depicted in FIG. 7 without departing from the scope of the technology as described herein. For example, two blocks shown in succession in FIG. 7 may in fact be executed substantially concurrently, or blocks may sometimes be executed in the reverse order depending upon the functionality involved.

The method 700 may include a step of sliding a first faceplate off of base plate guides, as depicted in block 702. The base plate may be mounted to a surface such as a horizontal or vertical surface through an opening formed therein. However, the base plate may be mounted to any surface and through any opening through a surface without departing from the technology described herein. The base plate may be electrically coupled to a power source, such as the primary power source described above, which may be located or mounted behind a panel, wall, or in a cabinet. In one or more embodiments, sliding the first faceplate off of the base plate guides further includes disengaging one or more locking features of the base plate or the first faceplate via applying to the first faceplate a sliding force sufficient to flex at least a portion of at least one of the one or more locking features. In some embodiments, the first faceplate may be pressed toward the base plate and upward, flexing one or more of the locking features and allowing the faceplate guides to slide along the base plate guides until fully removed from the base plate.

The method 700 may also include sliding a second faceplate onto the base plate guides until snapped together or otherwise secured or fixed onto the baseplate, as depicted in block 704. The snapping together may be performed with locking features of the base plate engage with locking features of the second faceplate, via spring-bias, flexing of plastic locking features, or the like. In some embodiments, instead of automatic snapping together of the locking features, the base plate and/or the faceplate being attached thereto may comprise stopping features and then may be manually locked into place with any manually interlocking configurations known in the art. In some embodiments, as depicted in FIG. 6, an edge of the base plate may be sized, shaped, or otherwise configured to abut a wall of a cutout region of the faceplate or to otherwise nest within the wall of the cutout region of the faceplate when the faceplate is slid onto and fully seated onto the base plate.

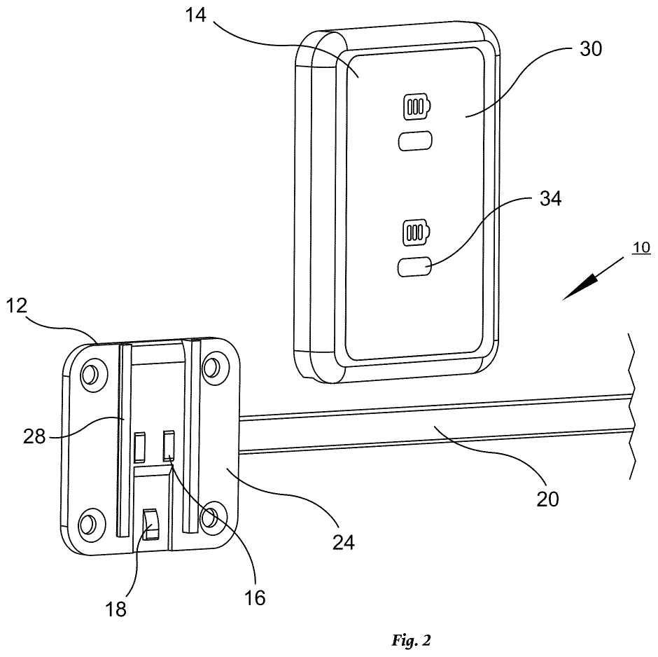

The method 700 may further comprise electrically coupling electrical contacts of the base plate and the second faceplate, as depicted in block 706. For example, as depicted in FIGS. 2 and 3, the electrical contacts may comprise electrical contact pads and even flexible, spring-biased contacts for engagement and/or interlocking with each other. This interlocking or engagement may provide additional locking support between the faceplate and the base plate, in addition to other locking features described above. The first faceplate and the second faceplate may comprise different styles or configurations of outlets, electronic accessories, or non-electronic accessories as described herein. Furthermore, as also described herein, the first faceplate or the second faceplate may even be a safety cover without any accessories associated therewith, such as a solid non-conductive cover that fully covers the conductive components of the base plate for electrical safety purposes.

In some embodiments, (e.g., once one faceplate is exchanged for another faceplate) the method 700 may comprise inserting an electrical plug into an outlet (e.g., an outlet port or socket) of the second faceplate, as depicted in block 708. That is, in embodiments where the second faceplate includes an outlet or female electrical socket configured for a first type of male electrical plug. The first type of male electrical plug may be attached to an electronic cable for charging of a rechargeable device or powering of any electronic device compatible with that particular electronic cable. However, in some alternative embodiments, the second faceplate or other faceplates may not include an electrical socket or outlet, but rather includes electronic accessories such as lights, speakers, or wireless power transfer devices (e.g., for wireless charging of phones, laptops, tablets, or the like).

In one or more embodiments, the method 700 may comprise converting, via electronic components of the second faceplate, a first voltage received from the base plate (e.g., 28V from the primary power source) to a second voltage (e.g., 5vdc) provided to the outlet of the second faceplate, as depicted in block 710, and/or provided to the electrical plug inserted into the outlet. For example, one of the faceplates may comprise outlets or other electronic accessories configured to make a conversion from aircraft power of 28V down to 5vdc (e.g., for USB charging or the like). This makes it easy to swap different faceplates due to the fact the base plate always supplies the same power and is controlled by hardware or circuitry built into one or more of the faceplates if or when needed to convert down to whatever the electricity requirement is for that faceplate's built in accessories, outlets, or the like. This allows for swapping unique accessories that would require the same amount of power or potentially swapping faceplates that have different power requirements than each other.

In some embodiments, a microswitch, proximity switch, or some other device that allows remote triggering of electronic accessories is installed and communicably coupled with wireless receivers or transceivers of one or more of the faceplates. So for example, a light of the faceplate may be triggered to come on in response to door being opened, as sensed by the microswitch or proximity sensor.

Advantageously, once the power base system's base plate is installed, any number of preconfigured options of faceplates can be installed in seconds. This allows for several advantages to prior methods such as upgrading technology (i.e. USB-A to USB-C styled outlets). In another example situation, during the sale of an aircraft, the new owner may use different hardware (e.g., Apple or Android) than the former owner and would like the aircraft's power supplies to match that new user's preferred devices. The power base system herein allows such swaps to be made in a matter of seconds without special tooling and without shutting off electricity to that outlet. In other example scenarios, some users may prefer wireless charging versus corded charging. This preference may be accommodated for via swapping the faceplate previously used for a faceplate with wireless charging capabilities built thereinto.

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A power base system comprising:
a base plate comprising:
a first non-conductive structure configured to be mounted through an opening in a surface and comprising one or more base plate guides, and
one or more electrically conductive elements extending through the first non-conductive structure and configured for wired attachment to a power source; and
one or more faceplates comprising:
a second non-conductive structure having one or more faceplate guides configured for selectively engaging with the one or more base plate guides and locking into place onto the base plate, and
one or more outlets or electronic accessories built into or extending through the second non-conductive structure and configured to electrically couple with the one or more electrically conductive elements.

2. The power base system of claim 1, wherein the one or more faceplates comprises two faceplates, wherein each of the two faceplates comprise different styles, configurations, or quantities of electrical outlets, electronic accessories, or non-electronic accessories than each other.

3. The power base system of claim 1, further comprising one or more wires or cords and a primary power source module providing electrical power via the one or more wires or cords to the one or more electrically conductive elements of the base plate.

4. The power base system of claim 1, wherein the one or more electrically conductive elements comprise electrical contacts, conductive pads, spring-biased conductive pads, or spring-biased pins.

5. The power base system of claim 1, wherein the faceplate guides and the base plate guides comprise rails or tracks configured to slidably engage with each other.

6. The power base system of claim 1, wherein at least one of the one or more faceplates comprises a non-electronic accessory in addition to the one or more outlets or electronic accessories.

7. The power base system of claim 1, wherein the one or more outlets or electronic accessories comprises a light.

8. The power base system of claim 1, wherein the one or more outlets or electronic accessories comprises a wireless power transfer device.

9. A power base system comprising:
a base plate comprising:
a first non-conductive structure configured to be affixed to a surface and extend at least partially through an opening in the surface, wherein the first non-conductive structure comprises one or more base plate guides, and
one or more electrically conductive elements extending through the first non-conductive structure and configured for wired attachment to a power source; and
at least one faceplate comprising:
a second non-conductive structure having one or more faceplate guides configured for selectively engaging with the one or more base plate guides, and
at least one locking feature configured to lock the at least one faceplate at a position fully seated onto the base plate.

10. The power base system of claim 8, wherein the at least one faceplate further comprises at least two faceplates, wherein a first one of the at least two faceplates is a solid non-conductive cover and a second one of the at least two faceplates comprises one or more outlets or electronic accessories built into or through the second non-conductive structure, wherein the one or more outlets or electronic accessories are configured to electrically couple with the one or more electrically conductive elements of the base plate.

11. The power base system of claim 8, wherein the at least one faceplate comprises two faceplates, wherein each of the two faceplates comprise different styles, configurations, or quantities of electrical outlets, electronic accessories, or non-electronic accessories than each other, wherein the base plate is configured to receive only one of the two faceplates at once.

12. The power base system of claim 8, further comprises one or more wires or cords and a primary power source module providing electrical power via the one or more wires or cords to the one or more electrically conductive elements.

13. The power base system of claim 8, wherein the at least one faceplate comprises one or more electrical contacts, conductive pads, spring-biased conductive pads, or spring-biased pins sized and configured to contact or engage with the one or more electrically conductive elements of the base plate.

14. The power base system of claim 8, wherein the faceplate guides and the base plate guides comprise rails or tracks configured to slidably engage with each other.

15. The power base system of claim 8, wherein the at least one faceplate comprises a non-electronic accessory extending away from the base plate.

16. The power base system of claim 8, wherein the at least one faceplate comprises one or more outlets or electronic accessories built into or through the second non-conductive structure, wherein the one or more outlets or electronic accessories comprises an outlet, a charging port, a light, a speaker, or a wireless power transfer device.

17. A method of reconfiguring a power base system with different physical or electronic accessories or outlets, the method comprising
sliding a first faceplate off of base plate guides of a base plate that is mounted to a surface, wherein the base plate is electrically coupled to a power source;
sliding a second faceplate onto the base plate guides until snapped together or otherwise secured or fixed onto the base plate;
electrically coupling electrical contacts of the base plate and the second faceplate; and
inserting an electrical plug into an outlet of the second faceplate.

18. The method of claim 17, further comprising converting, via electronic components of the second faceplate, a first voltage received from the base plate from the power source to a second voltage provided to the outlet of the second faceplate and to the electrical plug inserted into the outlet.

19. The method of claim 17, wherein sliding the first faceplate off the base plate guides further includes disengaging one or more locking features of the base plate or the first faceplate via applying to the first faceplate a sliding force sufficient to flex at least a portion of at least one of the one or more locking features.

20. The method of claim 17, wherein the first faceplate and the second faceplate comprise different styles or configurations of outlets, electronic accessories, or non-electronic accessories.
